(19) United States
(12) Patent Application Publication
(10) Pub. No.: US 2025/0130347 A1
(43) Pub. Date: Apr. 24, 2025

(54) COMPUTATIONAL ANALYSIS FOR EVALUATION OF LOCALIZED ATMOSPHERIC CONDITIONS TO ENHANCE ATMOSPHERIC DEPENDENT ELECTRICAL POWER GENERATION

(71) Applicant: INTERNATIONAL BUSINESS MACHINES CORPORATION, ARMONK, NY (US)

(72) Inventors: Manikandan Padmanaban, Chennai (IN); Sarbajit K. Rakshit, Kolkata (IN); Jagabondhu Hazra, Bangalore (IN)

(21) Appl. No.: 18/492,858

(22) Filed: Oct. 24, 2023

(51) Int. Cl. G01W 1/04; A01G 15/00; F03D 17/00; G01W 1/10

(52) U.S. Cl. CPC G01W 1/04; A01G 15/00; F03D 17/007; F03D 17/026; F03D 17/028; G01W 1/10

(57) ABSTRACT

Evaluating localized atmospheric conditions for selected cloud seeding to enhance localized electrical power generation from wind turbines by receiving, at a computer, wind farm data related to a plurality of wind turbines for generating electrical power at a location. The wind farm data collected from sensors at the location. An atmospheric condition in the atmosphere at the location is assessed by the computer, using the wind farm data and the data of the atmospheric conditions. The computer generates a prediction of an impact of the atmospheric condition on the atmospheric wind speed resulting in a wind turbine power output reduction. A determination is made when to initiate cloud seeding to generate rain at the location and reduce the atmospheric condition. Generating a communication to a control system which includes a recommendation to initiate the cloud seeding based on the prediction.

### BACKGROUND

The present disclosure relates to using artificial intelligence to evaluate local atmospheric conditions for enhancing atmospheric dependent electrical power generation such as wind turbines.

Aerosols are minute particles suspended in the atmosphere. When these particles are sufficiently large, their presence can be observed as they scatter and absorb sunlight. The aerosol particles can scatter sunlight and reduce visibility (for example, haze) and redden sunrises and sunsets.

Different sources of aerosols, for example, can be volcanic aerosol, desert dust, human-made aerosol, sea salt aerosol, etc. Aerosols can spread in the entire atmosphere, and there can be changes in physical and chemical properties in the atmosphere.

Because of levels of concentration of aerosols particles in the atmosphere, the windspeed can be reduced. It is found that aerosol particles, directly and through their enhancement of clouds, may reduce near-surface wind speeds below them by up to 8% locally.

### SUMMARY

The present disclosure recognizes the shortcomings and problems associated with current techniques for atmospheric dependent generating of electrical power such as using wind turbines. Embodiments of the present invention provide techniques for reducing the impact of aerosol in the air for maximum wind power generation at a location. In one example, artificial intelligence can be used to evaluate localized atmospheric conditions and generate a plan to reduce an atmospheric condition to enhance atmospheric dependent electrical power generation such as wind power generation using wind turbines.

There is a need for a system and method to manage the concentration of aerosol in the localized atmosphere to reduce the aerosol impact on the wind speed at the location. A method and system according to the present invention can leverage cloud seeding techniques to clear the aerosol concentration in the localized atmosphere to increase overall wind speed at the location, and thus enhance/increase the wind power generation. Such a method and system can also consider a cost benefit trade-off of the cost of cloud seeding to decrease localized aerosol as compared to the cost of reduced power generation when the aerosol concentration in the localized atmosphere is increase or high.

In an aspect according to the present invention, a computer-implemented method for evaluating localized atmospheric conditions for selected cloud seeding to enhance localized electrical power generation from wind turbines includes receiving, at a computer, wind farm data related to a plurality of wind turbines for generating electrical power at a location. The wind farm data can be collected from sensors at the location. The method includes receiving, at the computer, data of atmospheric conditions at least in part at the location, the data including atmospheric wind speed. The method includes assessing, using the computer, an atmospheric condition in the atmosphere at the location using the wind farm data and the data of the atmospheric conditions. The method includes predicting, using the computer, an impact of the atmospheric condition on the atmospheric wind speed resulting in a wind turbine power output reduction. The method includes determining, using the computer, when to initiate cloud seeding to generate rain at the location and reduce the atmospheric condition, in response to the prediction of the impact on the atmospheric wind speed meeting a threshold for the wind turbine power output reduction. The method includes generating a communication to a control system, the communication including a recommendation to initiate the cloud seeding based on the prediction of the impact on the atmospheric wind speed meeting the threshold for the wind turbine power output reduction.

The method can further include initiating the cloud seeding using the control system in response to the communication including the recommendation to initiate the cloud seeding.

The method can further include estimating an amount of cloud seeding to generate rain at the location to reduce the atmospheric condition; and sending the amount of cloud seeding and the impact prediction to a control system for initiating a cloud seeding technique.

The method can further comprise initiating the cloud seeding technique in response to the sending of the amount of cloud seeding and the impact prediction.

The predicting of the impact can include estimating spatio-temporal distribution of aerosol concentration and aerosol propagation in the atmosphere at the location.

The estimating of the amount of cloud seeding can be based on a volumetric analysis of the atmospheric conditions at the location, and a plan is generated, as part of the communication, to deploy cloud seeding to clear aerosol as the atmospheric condition to increase wind power generation.

The method can further include generating a cost-benefit analysis between a cost of the cloud seeding and a cost of wind turbine power output reduction.

The impact prediction can include estimating rainfall resulting from the cloud seeding and estimating a reduction amount of aerosol concentration in the atmosphere at the location, and estimating an increase in atmospheric wind speed, and estimating an increase in wind turbine power output resulting from the increase in atmospheric wind speed.

The wind turbine power output reduction can include a reduction in wind turbine power output.

The wind turbine power reduction can include a reduction in wind turbine power output resulting from a reduction in blade rotation speed caused by the atmospheric condition.

The atmospheric condition can include a spatial hotspot of aerosol concentration causing the impact on the atmospheric wind speed, and the impact is a slowing of the atmospheric wind speed resulting in a slowing of wind turbine blade rotation speeds causing the wind turbine power output reduction.

The control system can initiate the cloud seeding technique to reduce the atmospheric condition for increasing the atmospheric wind speeds resulting in an increase in wind turbine power output.

The method can further include a cloud seeding technique for the cloud seeding which includes using drones to seed clouds to produce rain to reduce the distribution of aerosol concentrations in the atmosphere at the location.

The method can further include generating, using the computer, a digital model using the received data of the atmospheric condition at least in part at the location; and using the model for the predicting of the impact of the atmospheric condition on the atmospheric wind speed.

The method can further include generating a digital model, using the computer; receiving updated wind farm data; receiving updated data of the atmospheric condition; the assessing of the atmospheric condition including using the digital model; the predicting of the impact of the atmospheric condition using the model; and the determining of whether to initiate cloud seeding to generate rain including using the model.

The method can further include iteratively generating the digital model to produce updated models.

A system for evaluating localized atmospheric conditions for selected cloud seeding to enhance localized electrical power generation from wind turbines. The system includes a computer system comprising; a computer processor, a computer-readable storage medium, and program instructions stored on the computer-readable storage medium being executable by the processor, to cause the computer system to perform the following functions to; receive, at a computer, wind farm data related to a plurality of wind turbines for generating electrical power at a location, the wind farm data collected from sensors at the location; receive, at the computer, data of atmospheric conditions at least in part at the location, the data including atmospheric wind speed; assess, using the computer, an atmospheric condition in the atmosphere at the location using the wind farm data and the data of the atmospheric conditions; predict, using the computer, an impact of the atmospheric condition on the atmospheric wind speed resulting in a wind turbine power output reduction; determine, using the computer, whether to initiate cloud seeding to generate rain at the location and reduce the atmospheric condition, in response to the prediction of the impact on the atmospheric wind speed meeting a threshold for the wind turbine power output reduction; and generate a communication to a control system, the communication including a recommendation to initiate the cloud seeding based on the prediction of the impact on the atmospheric wind speed meeting the threshold for the wind turbine power output reduction.

The system can further include the function to initiate the cloud seeding using the control system in response to the communication including the recommendation to initiate the cloud seeding.

The system can further include the functions to estimate an amount of cloud seeding to generate rain at the location to reduce the atmospheric condition; and send the amount of cloud seeding and the impact prediction to a control system for initiating a cloud seeding technique.

A computer program product for evaluating localized atmospheric conditions for selected cloud seeding to enhance localized electrical power generation from wind turbines. The computer program product includes a computer readable storage medium having program instructions embodied therewith, and the program instructions executable by a computer to cause the computer to perform functions, by the computer, comprising the functions to; receive, at a computer, wind farm data related to a plurality of wind turbines for generating electrical power at a location, the wind farm data collected from sensors at the location; receive, at the computer, data of atmospheric conditions at least in part at the location, the data including atmospheric wind speed; assess, using the computer, an atmospheric condition in the atmosphere at the location using the wind farm data and the data of the atmospheric conditions; predict, using the computer, an impact of the atmospheric condition on the atmospheric wind speed resulting in a wind turbine power output reduction; determine, using the computer, whether to initiate cloud seeding to generate rain at the location and reduce the atmospheric condition, in response to the prediction of the impact on the atmospheric wind speed meeting a threshold for the wind turbine power output reduction; and generate a communication to a control system, the communication including a recommendation to initiate the cloud seeding based on the prediction of the impact on the atmospheric wind speed meeting the threshold for the wind turbine power output reduction.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a schematic block diagram illustrating a system according to an embodiment of the present disclosure, for evaluating localized atmospheric conditions for selected cloud seeding to enhance localized electrical power generation from wind turbines.

FIG. 2 is a schematic block diagram illustrating another system according to an embodiment of the present disclosure, for evaluating localized atmospheric conditions for selected cloud seeding to enhance localized electrical power generation from wind turbines.

FIG. 3A is an equation directed to the relation between relative humidity and air density.

FIG. 3B is an equation directed to an optimization framework for harvesting maximum energy from wind turbines.

FIG. 4 is a flow chart illustrating a method according to an embodiment of the present invention which can use the systems depicted herein, for evaluating localized atmospheric conditions for selected cloud seeding to enhance localized electrical power generation from wind turbines.

FIG. 5 is a schematic block diagram, according to another embodiment of the present disclosure, depicting a system for evaluating localized atmospheric conditions for selected cloud seeding to enhance localized electrical power generation from wind turbines.

FIG. 6 is a schematic block diagram depicting a computer system according to an embodiment of the disclosure, which includes cloud computing components and functions, and which can cooperate with the systems and methods shown in the figures and described herein.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### Embodiments and Examples

Embodiments and figures of the present disclosure may have the same or similar components as other embodiments. Such figures and descriptions illustrate and explain further examples and embodiments according to the present disclosure. Embodiments of the present disclosure can include operational actions and/or procedures. A method, such as a computer-implemented method, can include a series of operational blocks for implementing an embodiment according to the present disclosure which can include cooperation with one or more systems shown in the figures. The operational blocks of the methods and systems according to the present disclosure can include techniques, mechanism, modules, and the like for implementing the functions of the operations in accordance with the present disclosure. Similar components may have the same reference numerals. Components can operate in concert with a computer implemented method. It is understood that a customer can be an individual, or a group of individuals, or a company or an organization.

A system and method according to the present disclosure can use satellite images, and radar signals to detect wind speed and the presence of aerosols in the atmosphere. Additionally, based on geo-location and pattern of light reflection, chemical particles in the atmosphere can also be detected.

In a more specific example, a system can use a combination of satellite observations (e.g., optical/microwave spectrum) and wind farm specific data (e.g., turbine layout, rated capacity, energy profile) to estimate a spatio-temporal distribution of aerosol concentration and its propagation. The system can leverage the atmospheric wind speed and directions to identify the spatial hotspot of aerosol and its impact on the reduction in wind speed/power. The system can further estimate the reduction in power generation during cloud seeding activity, and can estimate the required amount of cloud seeding based on a volumetric analysis. The system can deploy the optimal cloud seeding to clear the aerosol to maximize the overall wind power generation based on the cost-benefit analysis. Cloud seeding is an artificial way of inducing moisture in the clouds to cause rainfall. It is a form of weather modification.

In one example, a system and method can include performing cost benefit analysis. The cost benefit analysis includes determining an optimal set of hotspot locations for cloud seeding by considering the trade-off between the additional wind energy gained by clearing the hotspots of aerosol, and reduction in power generation during cloud seeding activity (decrease in air density during artificial rain), and cost incurred in deploying the cloud seeding.

The present disclosure provides a method and system to reduce the impact of aerosol for maximum wind power generation. Aerosols are minute particles suspended in the atmosphere. When these particles are sufficiently large, their presence is noticeable in the local atmosphere as they scatter and absorb sunlight. The scattering of sunlight can reduce visibility (haze) and redden sunrises and sunsets. Different sources of Aerosols can be, for example, volcanic aerosol, desert dust, human-made aerosol, sea salt aerosol, etc. Aerosol spreads in the entire atmosphere, and there can be changes in physical and chemical properties in the atmosphere. Because of levels of concentration of aerosols particles, the windspeed can be reduced. In one example, it is found that aerosol particles, directly and through their enhancement of clouds, may reduce near-surface wind speeds below them by up to 8% locally. A system and method according to the present disclosure can control the concentration of aerosol to reduce the impact on the wind speed. Further, a system according to the present disclosure can leverage cloud seeding techniques to clear aerosol concentration to increase overall wind speed, and thus the wind power generation considering the cost benefit trade-off.

In another example, a system according to the present disclosure can use a combination of satellite observations (optical/microwave spectrum) and wind farm specific data (turbine layout, rated capacity, energy profile) to estimate the spatio-temporal distribution of aerosol concentration and its propagation. The system can leverage the atmospheric wind speed and directions to identify a spatial hotspot of aerosol and its impact on the reduction in wind speed/power. The system can estimate the reduction in power generation during cloud seeding activity and estimate the required amount of cloud seeding based on the volumetric analysis and can deploy the optimal cloud seeding to clear the aerosol to maximize the overall wind power generation based on a cost-benefit analysis. In another example, a cost benefit analysis can be generated to determine the optimal set of hotspot location for cloud seeding by considering the trade-off between the additional wind energy gained by clearing the hotspots of aerosol, reduction in power generation during cloud seeding activity (decrease in air density during artificial rain), and cost incurred in deploying the cloud seeding.

In one embodiment, a system can identify the presence and propagation of aerosols distribution around a wind farm plant by leveraging the satellite observation and earth system models. In one example, for a wind farm turbine layout, spatio-temporal hotspots of aerosol locations are identified by leveraging the estimated aerosol distribution and the wind speed and direction. For each hotspot, the amount of reduction of wind speed/reduction due to the concentration of aerosol is estimated based on a created temperature inversion and reduction in vertical turbulence of horizontal flux (transfer of wind from higher altitude to lower altitude). For each hotspot, the amount of required cloud seeding is estimated based on the aerosol volumetric analysis. A system can optimally deploy the cloud seeding for clearing the aerosol based on a cost benefit analysis of additional wind speed/energy gained by clearing the aerosol. And the system can determine the cost involved in cloud seeding, and the impact of artificial rain on decreasing the air density during cloud seeding activity (thus the reduction in wind power generation due to decrease in air density).

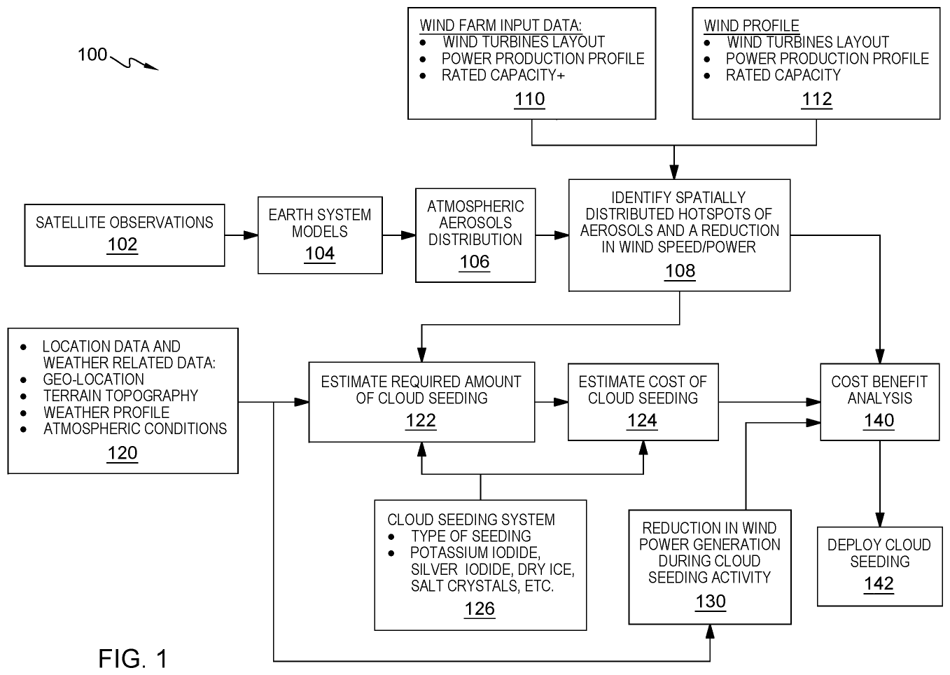

Referring to FIG. 1, according to an embodiment of the present disclosure, a computer implemented system 100 is depicted for evaluating localized atmospheric conditions for selected cloud seeding to enhance localized electrical power generation from wind turbines. The system is adapted to, using one or more computer systems individually or in concert, identify the presence and propagation of aerosols distribution in the vicinity of a wind farm by leveraging satellite observation and earth system models.

The system 100 includes exemplary system architecture including receiving or capturing satellite observations, as in operation 102, which can include multispectral/hyperspectral optical and microwave data from weather observation instruments. The satellite observations can be used in earth system models, as in operation 104, reflecting weather systems in the atmosphere. The system can include models of atmospheric aerosol distribution in the atmosphere, as in operation 106. The system can identify spatially distributed hotspots of aerosols and reduction in wind speed and/or power, as in operation 108, in one example, in a learning digital model.

Wind farm data as inputs, at operation 110, can include wind turbines layout, a power production profile, and a rated capacity. Wind profile data, as in operation 112, can include also include spatial distribution of wind magnitude and directions. Both the wind farm input data 110 and the wind profile data 112 are inputs for the operation 108.

The system also includes capturing or receiving location and weather related data, as in operation 120, such as a geolocation of a wind farm, terrain topography, and a weather profile which can include humidity, wind, or temperature. The system can also include receiving or capturing atmospheric condition data such as atmospheric pressure, etc., as in operation 120. The system can includes estimating a required amount of cloud seeding using, for example, a volumetric analysis, as in operation 122, using data received from operation 108. The system can then estimate a cost of cloud seeding at operation 124. The operations 122 and 124 can use data with respect to a cloud seeding system, received from operation 126, including types of seeding, such as, potassium iodide, silver iodide, dry ice, salt crystals, or other processes. A reduction in wind power generation during cloud seeding activity, in operation 130, can be generated using data from operation 120.

A cost benefit analysis, in operation 140, uses data from operations 124 and 130, and 108, and may include energy production versus cloud seeding. The system can deploy cloud seeding as in operation 142.

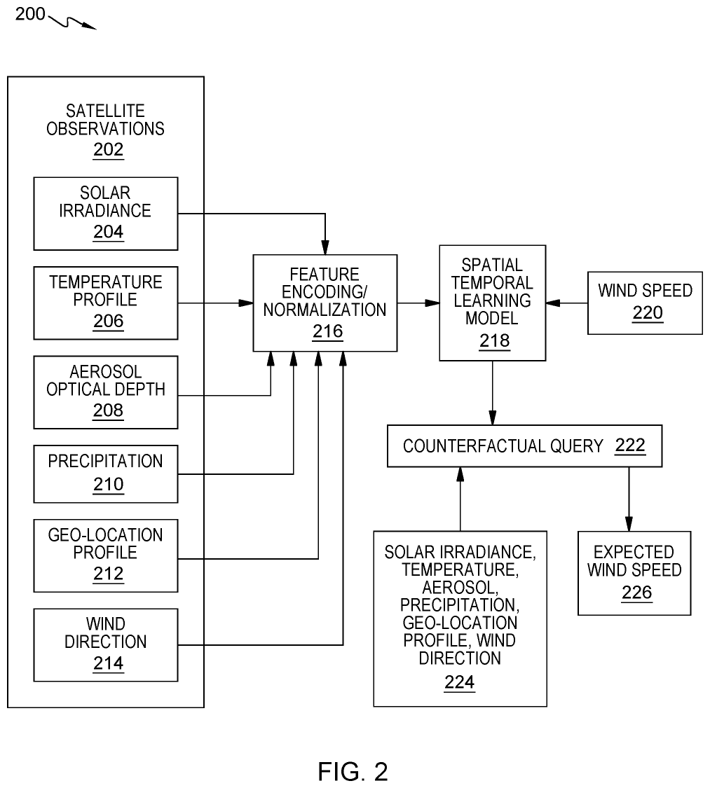

Referring to FIG. 2, a system 200 for deriving impact of aerosol on wind speed and/or power is shown. Satellite observations 202 include solar irradiance 204, temperature profile 206, aerosol optical depth 208, precipitation 210, geo-location profile 212 (e.g., using GPS (Global Positioning System)) which can include, for example, topography, pressure, etc., and wind direction 214. The satellite observations 202 provide input for feature encoding and/or normalization, in operation 216. The system 200 includes a spatial temporal learning model 218 which includes an input of wind speed 220. The system 200 includes a counterfactual query, in operation 222, generated from the model 218. Input into the counterfactual query can include, for example, solar irradiance, temperature, aerosol, precipitation, geolocation, geolocation profile, and wind direction, as in operation 224. The counterfactual query can include an output of expected wind speed, as in operation 226.

For a counterfactual query “c”, equation 1 below can be used.

c=arg min yloss(f(c),y)+|x−c|. Equation 1:

Where ‘c’ is the list of input candidates such as solar irradiance, temperature, aerosol, precipitation, geolocation profile, and wind direction. The variable ‘x’ is the original or current state of inputs. f(c) is the function of list of candidates which gives the expected wind speed. The variable ‘y’ is the actual wind speed.

Power can be calculated as Power=½ CρAV³. Where ρ is air density; C is a coefficient of performance; A is a frontal area; and V is the velocity of the wind.

Using the system 200, for a given aerosol (which is cleared) and other atmospheric parameters, the counterfactual framework can provide the expected increase in wind speed using the expected wind speed 226 and the wind speed 220. The power output is proportional to cubic power of wind speed. Spatio-temporal potential power gain for a given wind farm can be estimated from the relation of power output and cubic power of wind speed, by clearing the aerosol in the wind flow path.

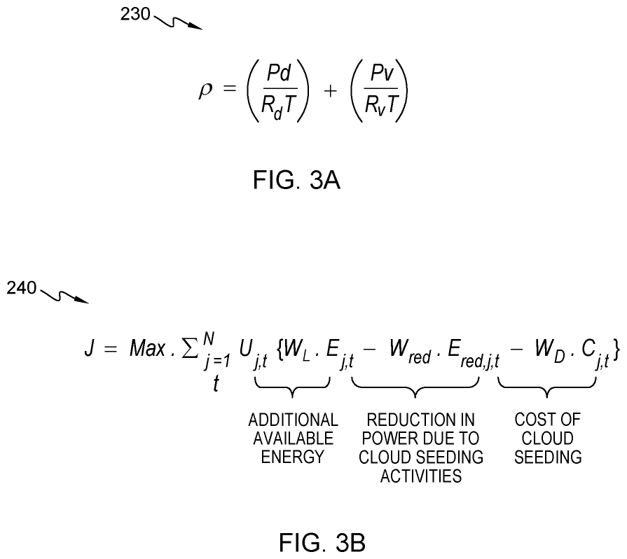

Power reduction due to cloud seeding activity can be calculated. During cloud seeding activity (e.g., artificial rain), the relative humidity can be one hundred percent and thus impacts (e.g., decreases) air density according to equation 230 shown in FIG. 3A. In the equation 230,

ρᵥ=ρ₁×RH

ρ₁=6.1078×10^{7.5T/T+237.3}

ρ_{d}=ρ−ρᵥ

Where P is the total air pressure in Pa. ρ_{d} is the pressure of dry air in Pa. ρᵥ is the water vapor pressure in Pa. T is the air temperature in Kelvins (K). R_{d} is the specific gas constant for dry air equal to 287.058 J/(kg-K). And Rᵥ is the specific gas constant for water vapor equal to 461.495 J (Joule)/kg (kilogram)-K.

Power is defined as discussed above as: Power=½ CρAV³. P is air density. C is a coefficient of performance. A is a frontal area. V is the velocity of the wind. Power reduction can be calculated by finding the difference between potential power generation without and with artificial rain. Cloud seeding activity is performed during the lower wind speed or when the wind turbine is at a stalled condition to ensure the minimal loss of power generation due to decrease in air density (e.g., decrease in wind power production).

In one example, of an optimization framework, an N number of identified spatial hotspots of aerosol concentration in a grid. An optimal set of “j” is selected such that the maximum energy can be harvested from wind turbines by clearing the aerosol through cloud seeding to increase the wind speed for harvesting additional energy; minimize the power reduction from wind farm power generation due to decrease in air density during cloud seeding activities; and minimizing the overall cost of deploying cloud seeding. J can be represented by an equation 240 shown in FIG. 3B. J is the cost function (e.g., energy gain). uⱼ is a binary decision variable (e.g., optimal identified hotspot pixel “j”). Eⱼ is additional available energy after clearing the aerosol at pixel “j”. Cⱼ is the cost of cloud seeding at pixel “j”. E_{red} is power reduction in wind farm during cloud seeding activity (e.g., decrease in air density at time “t” for a pixel “j”. w_{L}, w_{D}, w_{red} are weighing coefficients for additional energy generation, expense for cloud seeding and the power reduction during cloud seeding activity respectively.

In one example, a business example can include considering a typical wind turbine with rated capacity 1 MW (megawatt) with 50 m (meter) diameter. Assuming an average wind speed of 7 miles/second. Empirically the effect of aerosol reduces the base speed of 8%. Thus, an average speed reduces to 6.4 miles/second. In one case, assume the relative humidity is zero before clouds seeding. During could seeding activity, the relative humidity can be close to 100%. At 40 deg C. (Celsius), the normalized air density reduced from 0.95 (0% relative humidity) to 0.9 for 100% relative humidity. In one case, during cloud seeding activity, the gain in wind power production can be 17% higher, that is 7/6.4 \hat{ }3*0.9.

Thus, methods and systems according to the present disclosure estimate the hotspots of aerosol and its impact on power reduction and leverages cloud seeding to increase the overall power generation based on a cost benefit analysis.

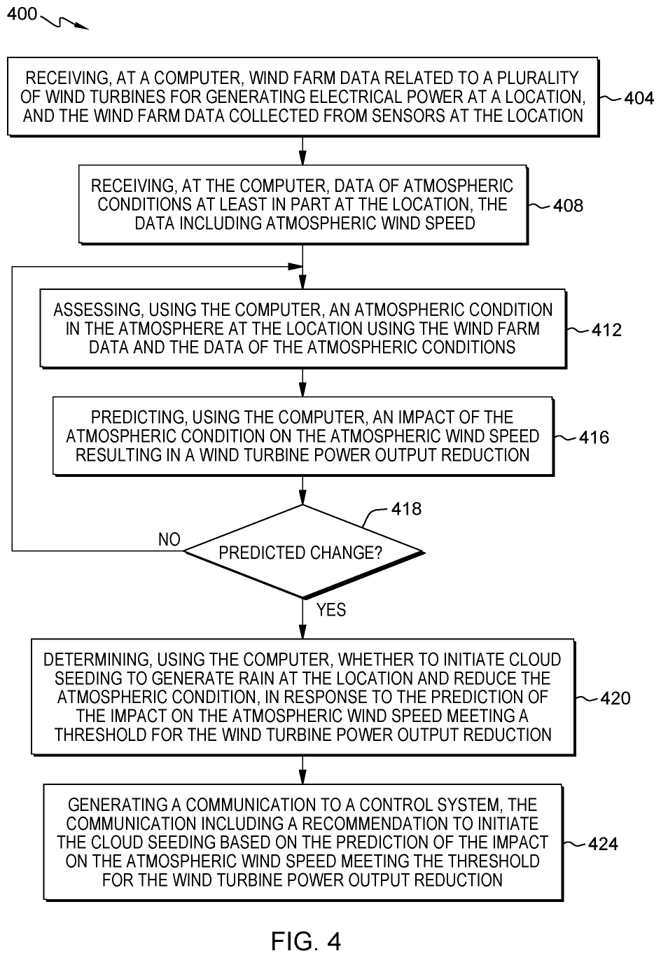

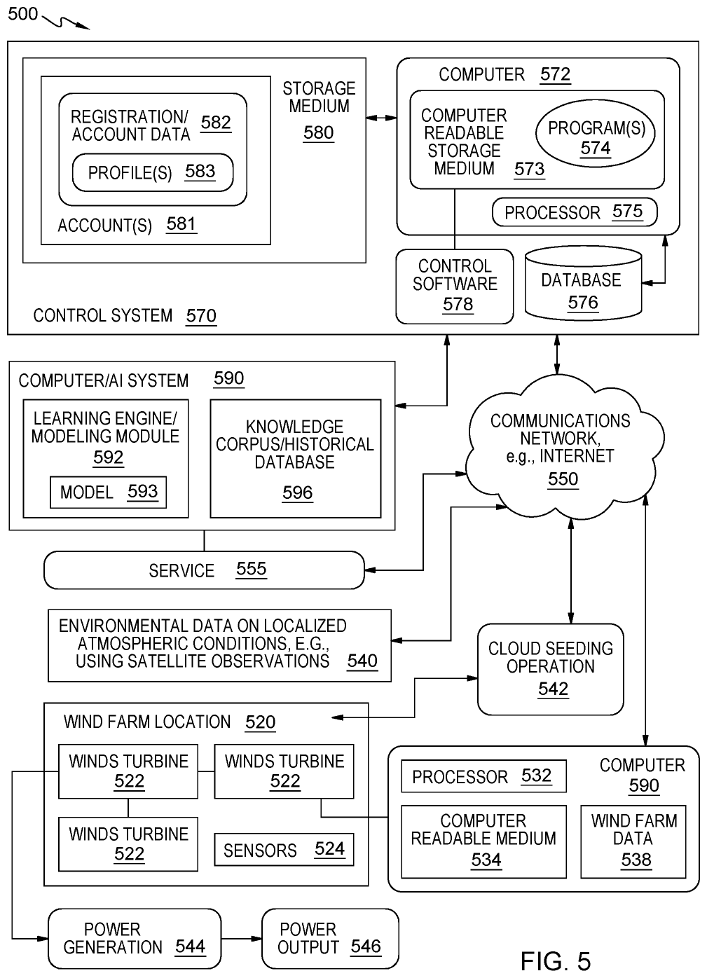

Referring to FIGS. 4 and 5, in one embodiment according to the present disclosure, a computer implemented method 400 (shown in FIG. 4), utilizing an exemplary system 500 (shown in FIG. 5) can evaluate localized atmospheric conditions 540 for selected cloud seeding operations 542 to enhance localized electrical power generation 544 and power output 546 from wind turbines 522.

The method 400 includes receiving, at a computer 530, wind farm data 538 related to a plurality of wind turbines 522 for generating electrical power 544 at a location 520, as in operation 404. The wind farm data collected from sensors 524 at the location 520, as in operation 404. The wind farm data 538 can include sensor data from the sensors 524, and environmental data 540 communicated to the computer 530, for example, directly using a direct transmission link or using a communications network 550. The computer includes a processor 532, computer readable storage medium 534.

The method includes receiving, at the computer, data of atmospheric conditions at least in part at the location, the data including atmospheric wind speed, as in operation 408. The method includes assessing, using the computer, an atmospheric condition in the atmosphere at the location (e.g., using spatio-temperal distribution) using the wind farm data and the data of the atmospheric conditions, as in operation 412. For example, the method can include identifying an atmospheric condition and assessing the atmospheric condition to determine a type and/or severity of the atmospheric condition.

The method includes predicting and/or estimating, using the computer, an impact of the atmospheric condition on the atmospheric wind speed resulting in a wind turbine power output reduction, including a wind speed change that results in a wind speed reduction, as in operation 416. When a predicted change occurs, as detected in operation 418, the method continues to operation 420. When a predicted change does not occur, as detected in operation 418, the method can return to operation 412.

The method includes determining, using the computer, whether to initiate cloud seeding to generate rain at the location and reduce and/or negate the atmospheric condition, in response to the prediction of the impact on the atmospheric wind speed meeting a threshold for the wind turbine power output reduction, as in operation 410.

The method includes generating a communication to a control system 570, as in operation 424. The communication includes a recommendation to initiate the cloud seeding based on the prediction of the impact on the atmospheric wind speed meeting the threshold for the wind turbine power output reduction, also as in operation 424.

Additionally, in one embodiment, the system 500 shown in FIG. 5, can be used to implement the method 400. The system 500 includes computer 530 communicating with a control system 570 via a communications network 550, such as in the Internet. In one example, one or more functions of the method 400 can be run as a service 555. In another example, a control system 570 can include a computer 572 including a processor 575 and a computer readable storage medium 573 where an application or program(s) 574 can be stored which can in one example, embody all or part of the method of the present disclosure as work instructions for execution by the processor. The application can include all or part of instructions to implement the method of the present disclosure, embodied in code and stored on a computer readable storage medium. The computer 572 can use control software 578 for implementing functions according to the present disclosure and also access a database 576. The computer or a device 572 can include a display or monitor, likewise the computer 530 can also include a display. The computer 530 can operate, in all or in part, in conjunction with a remote server by way of the communications network 550, for example, the Internet. Likewise, the computer 572 can communicate with the computer 530 by way of the network 550. In another example, a computer or AI (artificial intelligence) system 590 can communicate with the control system and can use a learning engine 592 and a knowledge corpus 596 to generate one or more model 593 implementing the functions of the present disclosure. In another example, storage medium 580 of the control system 570 can include registration or account data 582 including user profiles 583 as part of accounts 581 storing account data for user accounts.

In one example, the method 400 can further include initiating the cloud seeding using the control system in response to the communication including the recommendation to initiate the cloud seeding.

In one example, the method 400 can include estimating an amount of cloud seeding to generate rain at the location to reduce the atmospheric condition, and sending the amount of cloud seeding and the impact prediction to a control system for initiating a cloud seeding technique.

In one example, the method can include the cloud seeding technique in response to the sending of the amount of cloud seeding and the impact prediction.

In another example, the predicting of the impact includes estimating spatio-temporal distribution of aerosol concentration and aerosol propagation in the atmosphere at the location, which can include leveraging atmospheric wind speed and directions.

In another example, the estimating of the amount of cloud seeding can be based on a volumetric analysis of the atmospheric conditions at the location, and a plan can be generated, as part of the communication, to deploy cloud seeding to clear aerosol as the atmospheric condition to increase wind power generation.

The method can further include generating a cost-benefit analysis between a cost of the cloud seeding and a cost of wind turbine power output reduction.

The method can include the impact prediction including estimating rainfall resulting from the cloud seeding and estimating a reduction amount of aerosol concentration in the atmosphere at the location, and estimating an increase in atmospheric wind speed, and estimating an increase in wind turbine power output resulting from the increase in atmospheric wind speed.

The method can include the wind turbine power output reduction including a reduction in wind turbine power output.

The method can include the wind turbine power reduction including a reduction in wind turbine power output resulting from a reduction in blade rotation speed caused by the atmospheric condition.

The method can include the atmospheric condition including a spatial hotspot of aerosol concentration causing the impact on the atmospheric wind speed, and the impact including a slowing of the atmospheric wind speed resulting in a slowing of wind turbine blade rotation speeds causing the wind turbine power output reduction.

The method can include the control system initiating the cloud seeding technique to reduce the atmospheric condition for increasing the atmospheric wind speeds resulting in an increase in wind turbine power output.

The method can further include a cloud seeding technique for the cloud seeding which includes using drones to seed clouds to produce rain to reduce the distribution of aerosol concentrations in the atmosphere at the location.

The method can further include generating, using the computer, a digital model using the received data of the atmospheric condition at least in part at the location; and using the model for the predicting of the impact of the atmospheric condition on the atmospheric wind speed.

The method can further include generating a digital model, using the computer; receiving updated wind farm data; receiving updated data of the atmospheric condition; the assessing of the atmospheric condition including using the digital model; the predicting of the impact of the atmospheric condition using the model; and the determining of whether to initiate cloud seeding to generate rain including using the model. The method can further include iteratively generating the digital model to produce updated models.

### Additional Embodiments and Examples

The method can include an analysis generating a computational model based on received data. A model can also be generated by an AI system, at least in part. In one example, an AI system can generate a model using an AI system analysis using machine learning. A model, for example, can use received weather data to generate weather and wind predictions for a locale. A computer implemented method as disclosed herein can include modeling, using the computer. The model can be generated using a learning engine or modeling module of a computer system which can be all or in part of an Artificial Intelligence (AI) system which communicates with the computer and/or a control system. Such a computer system can include or communicate with a knowledge corpus or historical database. In one example, an acceptable model can include a model meeting specified parameters. In another example, an acceptable model can be a model which has undergone several iterations of modeling. When the model is not acceptable, the method can return to return to a previous operation or proceed as directed, for example as represented by an operational block in a flowchart.

In one example according to the present disclosure, a method can generate a model, using a computer, which can include a series of operations. The model can be generated using a learning engine or modeling module of a computer system which can be all or in part of an Artificial Intelligence (AI) system which communicates with a computer and/or a control system. Such a computer system can include or communicate with a knowledge corpus or historical database.

The model can be generated using a learning engine or modeling module of a computer system which can be all or in part of an Artificial Intelligence (AI) system which communicates with a computer and/or a control system. Such a computer system can include or communicate with a knowledge corpus or historical database. A model can also be generated by an AI system such as an output at least in part of an AI system analysis using machine learning.

In other embodiments and examples, in the present disclosure shown in the figures, a computer can be part of a remote computer or a remote server, for example, a remote server. In another example, the computer can be part of a control system and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs. A device(s), for example a mobile device or mobile phone, can belong to one or more users, and can be in communication with the control system via the communications network.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the device can include a computer having a processor and a storage medium which stores an application, and the computer includes a display. The application can incorporate program instructions for executing the features of the present disclosure using the processor. In another example, the mobile device application or computer software can have program instructions executable for a front end of a software application incorporating the features of the method of the present disclosure in program instructions, while a back end program or programs, of the software application, stored on the computer of the control system communicates with the mobile device computer and executes other features of the method. The control system and the device (e.g., mobile device or computer) can communicate using a communications network, for example, the Internet.

Methods and systems according to embodiments of the present disclosure, can be incorporated in one or more computer programs or an application stored on an electronic storage medium, and executable by the processor, as part of the computer on mobile device. For example, a mobile device can communicate with the control system, and in another example, a device such as a video feed device can communicate directly with the control system. Other users (not shown) may have similar mobile devices which communicate with the control system similarly. The application can be stored, all or in part, on a computer or a computer in a mobile device and at a control system communicating with the mobile device, for example, using the communications network, such as the Internet. It is envisioned that the application can access all or part of program instructions to implement the method of the present disclosure. The program or application can communicate with a remote computer system via a communications network (e.g., the Internet) and access data, and cooperate with program(s) stored on the remote computer system. Such interactions and mechanisms are described in further detail herein and referred to regarding components of a computer system, such as computer readable storage media, which are shown in one or more embodiments herein and described in more detail in regards thereto referring to one or more computers and systems described herein.

Also, referring to the figures, a device can include a computer, computer readable storage medium, and operating systems, and/or programs, and/or a software application, which can include program instructions executable using a processor. Embodiments of these features are shown herein in the figures. The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

Referring to one or more embodiments in the figures, a computer or a device, also can be referred to as a user device or an administrator's device, includes a computer having a processor and a storage medium where an application can be stored. The application can embody the features of the method of the present disclosure as instructions. The user can connect to a learning engine using the device. The device which includes the computer and a display or monitor. The application can embody the method of the present disclosure and can be stored on the computer readable storage medium. The device can further include the processor for executing the application/software. The device can communicate with a communications network, e.g., the Internet.

It is understood that the user device is representative of similar devices which can be for other users, as representative of such devices, which can include, mobile devices, smart devices, laptop computers etc.

### Additional Examples and Embodiments

In one example, a system according to the present disclosure can include a control system communicating with a user device via a communications network. The control system can incorporate all or part of an application or software for implementing the method of the present disclosure. The control system can include a computer readable storage medium where account data and/or registration data can be stored. User profiles can be part of the account data and stored on the storage medium. The control system can include a computer having computer readable storage medium and software programs stored therein. A processor can be used to execute or implement the instructions of the software program. The control system can also include a database.

A control system can include a storage medium for maintaining a registration of users and their devices for analysis of the audio input. Such registration can include user profiles, which can include user data supplied by the users in reference to registering and setting-up an account. In an embodiment, the method and system which incorporates the present disclosure includes the control system (generally referred to as the back-end) in combination and cooperation with a front end of the method and system, which can be the application. In one example, the application is stored on a device, for example, a computer or device on location, and can access data and additional programs at a back end of the application, e.g., control system.

Referring to the figures, for example FIG. 5, a system 500 includes a computer 590 which can be integral to or communicating with a device and can communicate with other computers. A computer 590 can electronically communicate, in all or in part, with a control system computer 572 as part of a control system 570. The control system 570 can include the computer 572 having a computer readable storage medium 573 which can store one or more programs 574, and a processor 575 for executing program instructions, and can also include control software 538 for managing the one or more programs. The control system 570 can include control software 578. The control system can also include a storage medium which can include registration and/or account data 582 and user profiles 583 of users or entities (such entities can include robotic entities) as part of user accounts 581. User accounts 581 can be stored on a storage medium 580 which is part of the control system 570. The user accounts 581 can include registrations and account data 582 and user profiles 583. The control system can also include the computer 572 having a computer readable storage medium 573 which can store programs or code embedded on the storage medium. The program code can be executed by a processor 575. The computer 572 can communicate with a database 576. The control system 570 can also include a database 576 for storing all or part of such data as described above, and other data.

The control system can also communicate with a computer system 590 which can include a learning engine/module 592 and a knowledge corpus or database 596. The computer system 590 can also communicate with the computer 530. In another example, the computer system 590 can be all or part of the control system, or all or part of a device. The depiction of the computer system 590 as well as the other components of the system 500 are shown as one example according to the present disclosure. One or more computer systems can communicate with a communications network 550, e.g., the Internet. Thus, in one example, a control system can be in communication with a computer or device, and the computer can include an application or software. The computer, or a computer in a mobile device can communicate with the control system using the communications network. In another example, the control system can have a front-end computer belonging to one or more users, and a back-end computer embodied as the control system.

The control system can also be part of a software application implementation, and/or represent a software application having a front-end user part and a back-end part providing functionality. In an embodiment, the method and system which incorporates the present disclosure includes the control system (which can be generally referred to as the back-end of the software application which incorporates a part of the method and system of an embodiment of the present application) in combination and cooperation with a front end of the software application incorporating another part of the method and system of the present application at the device, which may be shown, for example, in the example figures, for instance an application stored on a computer readable storage medium of a computer or device. The application is stored on the device or computer and can access data and additional programs at the back end of the application, for example, in the program(s) stored in the control system.

### Still Further Embodiments and Examples

Account data, for instance, including profile data related to a user, and any data, personal or otherwise, can be collected and stored, for example, in a control system. It is understood that such data collection is done with the knowledge and consent of a user, and stored to preserve privacy, which is discussed in more detail below. Such data can include personal data, and data regarding personal items.

In one example a user can register and have an account with a user profile on a control system. For example, data can be collected using techniques as discussed above, for example, using cameras, and data can be uploaded to a user profile by the user. A user can include, for example, a corporate entity, or department of a business, or a homeowner, or any end user, a human operator, or a robotic device, or other personnel of a business.

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user's option to cancel such profile or account, and/or input of data, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

In one or more embodiments of the present invention, a user(s) can opt-in or register with a control system, voluntarily providing data and/or information in the process, with the user's consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner. A user interface can also allow a user or an individual to remove all their historical data.

### Other Additional Embodiments and Examples

In one example, Artificial Intelligence (AI) can be used, all or in part, for generating a model or a learning model as discussed herein in embodiments of the present disclosure. An Artificial Intelligence (AI) System can include machines, computer, and computer programs which are designed to be intelligent or mirror intelligence. Such systems can include computers executing algorithms. AI can include machine learning and deep learning. For example, deep learning can include neural networks. An AI system can be cloud based, that is, using a cloud-based computing environment having computing resources. In another example, a control system can be all or part of an Artificial Intelligence (AI) system. For example, the control system can be one or more components of an AI system.

In one example, a new or different AI (Artificial Intelligence) ecosystem, or technology/communication or IT (Information Technology) ecosystem can include a local communications network which can communicate with the communications network 160. The system 100 can include a learning engine/module 192, which can be at least part of the control system or communicating with the control system, for generating a model 593XX or learning model. In one example, the learning model can model workflow in a new AI or IoT (Internet of Things) ecosystem for machine/devices in the new ecosystem.

It is also understood that methods and systems according to embodiments of the present disclosure, can be incorporated into (Artificial Intelligence) AI devices, components or be part of an AI system, which can communicate with respective AI systems and components, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

It is understood that as discussed herein, a download or downloadable data can be initiated using a voice command or using a mouse, touch screen, etc. In such examples a mobile device can be user initiated, or an AI device can be used with consent and permission of users. Other examples of AI devices include devices which include a microphone, speaker, and can access a cellular network or mobile network, a communications network, or the Internet, for example, a vehicle having a computer and having cellular or satellite communications, or in another example, IoT (Internet of Things) devices, such as appliances, having cellular network or Internet access.

### More Examples and Embodiments

Additionally, methods and systems according to embodiments of the present disclosure can be discussed in relation to a functional system(s) depicted by functional block diagrams. The methods and systems can include components and operations for embodiments according to the present disclosure and is used herein for reference when describing the operational steps of the methods and systems of the present disclosure. Additionally, the functional system, according to an embodiment of the present disclosure, depicts functional operations indicative of the embodiments discussed herein.

The methods and systems of the present disclosure can include a series of operational blocks for implementing one or more embodiments according to the present disclosure. A method shown in the figures may be another example embodiment, which can include aspects/operations shown in another figure and discussed previously but can be reintroduced in another example. Thus, operational blocks and system components shown in one or more of the figures may be similar to operational blocks and system components in other figures. The diversity of operational blocks and system components depict example embodiments and aspects according to the present disclosure. For example, methods shown are intended as example embodiments which can include aspects/operations shown and discussed previously in the present disclosure, and in one example, continuing from a previous method shown in another flow chart.

It is understood that the features shown in some of the figures, for example block diagrams, are functional representations of features of the present disclosure. Such features are shown in embodiments of the systems and methods of the present disclosure for illustrative purposes to clarify the functionality of features of the present disclosure.

### Further Discussion Regarding Examples and Embodiments

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants.

The descriptions of the various embodiments of the present invention have been presented for purposes of illustration but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is also understood that the one or more computers or computer systems shown in the figures can include all or part of a computing environment and its components shown in another figure, for example, the computing environment 1000 can be incorporated, in all or in part, in one or more computers or devices shown in other figures and described herein. In one example, the one or more computers can communicate with all or part of a computing environment and its components as a remote computer system to achieve computer functions described in the present disclosure.

### Additional Examples and Embodiments

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

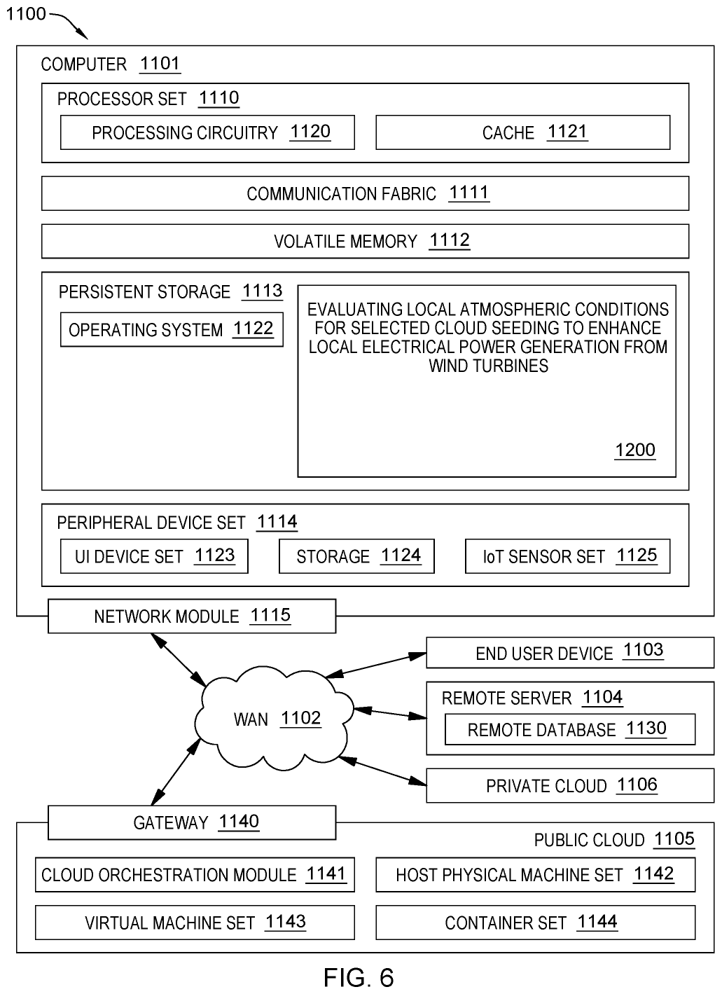

Referring to FIG. 6, a computing environment 1000 contains an example of an environment for the execution of at least some of the computer code involved in performing the inventive methods, such as evaluating local atmospheric conditions for selected cloud seeding to enhance local electrical power generation from wind turbines 1200. In addition to block 1200, computing environment 1000 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1200, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 7. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1200 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

What is claimed is:

1. A computer implemented method for evaluating localized atmospheric conditions for selected cloud seeding to enhance localized electrical power generation from wind turbines, comprising:
receiving, at a computer, wind farm data related to a plurality of wind turbines for generating electrical power at a location, the wind farm data collected from sensors at the location;
receiving, at the computer, data of atmospheric conditions at least in part at the location, the data including atmospheric wind speed;
assessing, using the computer, an atmospheric condition in the atmosphere at the location using the wind farm data and the data of the atmospheric conditions;
predicting, using the computer, an impact of the atmospheric condition on the atmospheric wind speed resulting in a wind turbine power output reduction;
determining, using the computer, when to initiate cloud seeding to generate rain at the location and reduce the atmospheric condition, in response to the prediction of the impact on the atmospheric wind speed meeting a threshold for the wind turbine power output reduction; and
generating a communication to a control system, the communication including a recommendation to initiate the cloud seeding based on the prediction of the impact on the atmospheric wind speed meeting the threshold for the wind turbine power output reduction.

2. The method of claim 1, further comprising:
initiating the cloud seeding using the control system in response to the communication including the recommendation to initiate the cloud seeding.

3. The method of claim 1, further comprising:
estimating an amount of cloud seeding to generate rain at the location to reduce the atmospheric condition; and
sending the amount of cloud seeding and the impact prediction to a control system for initiating a cloud seeding technique.

4. The method of claim 3, further comprising:
initiating the cloud seeding technique in response to the sending of the amount of cloud seeding and the impact prediction.

5. The method of claim 1, wherein the predicting of the impact includes estimating spatio-temporal distribution of aerosol concentration and aerosol propagation in the atmosphere at the location.

6. The method of claim 3, wherein the estimating of the amount of cloud seeding is based on a volumetric analysis of the atmospheric conditions at the location, and a plan is generated, as part of the communication, to deploy cloud seeding to clear aerosol as the atmospheric condition to increase wind power generation.

7. The method of claim 1, further comprising:
generating a cost-benefit analysis between a cost of the cloud seeding and a cost of wind turbine power output reduction.

8. The method of claim 1, wherein the impact prediction includes estimating rainfall resulting from the cloud seeding and estimating a reduction amount of aerosol concentration in the atmosphere at the location, and estimating an increase in atmospheric wind speed, and estimating an increase in wind turbine power output resulting from the increase in atmospheric wind speed.

9. The method of claim 1, wherein the wind turbine power output reduction includes a reduction in wind turbine power output.

10. The method of claim 1, wherein the wind turbine power reduction includes a reduction in wind turbine power output resulting from a reduction in blade rotation speed caused by the atmospheric condition.

11. The method of claim 1, wherein the atmospheric condition includes a spatial hotspot of aerosol concentration causing the impact on the atmospheric wind speed, and the impact is a slowing of the atmospheric wind speed resulting in a slowing of wind turbine blade rotation speeds causing the wind turbine power output reduction.

12. The method of claim 1, wherein the control system initiates the cloud seeding technique to reduce the atmospheric condition for increasing the atmospheric wind speeds resulting in an increase in wind turbine power output.

13. The method of claim 1, further comprising
a cloud seeding technique for the cloud seeding which includes using drones to seed clouds to produce rain to reduce the distribution of aerosol concentrations in the atmosphere at the location.

14. The method of claim 1, further comprising:
generating, using the computer, a digital model using the received data of the atmospheric condition at least in part at the location; and
using the model for the predicting of the impact of the atmospheric condition on the atmospheric wind speed.

15. The method of claim 14, further comprising:
generating a digital model, using the computer;
receiving updated wind farm data;
receiving updated data of the atmospheric condition;
the assessing of the atmospheric condition including using the digital model;
the predicting of the impact of the atmospheric condition using the model; and
the determining of whether to initiate cloud seeding to generate rain including using the model.

16. The method of claim 15, further comprising:
iteratively generating the digital model to produce updated models.

17. A system for evaluating localized atmospheric conditions for selected cloud seeding to enhance localized electrical power generation from wind turbines, which comprises:
a computer system comprising; a computer processor, a computer-readable storage medium, and program instructions stored on the computer-readable storage medium being executable by the processor, to cause the computer system to perform the following functions to;
receive, at a computer, wind farm data related to a plurality of wind turbines for generating electrical power at a location, the wind farm data collected from sensors at the location;
receive, at the computer, data of atmospheric conditions at least in part at the location, the data including atmospheric wind speed;
assess, using the computer, an atmospheric condition in the atmosphere at the location using the wind farm data and the data of the atmospheric conditions;
predict, using the computer, an impact of the atmospheric condition on the atmospheric wind speed resulting in a wind turbine power output reduction;
determine, using the computer, whether to initiate cloud seeding to generate rain at the location and reduce the atmospheric condition, in response to the prediction of the impact on the atmospheric wind speed meeting a threshold for the wind turbine power output reduction; and
generate a communication to a control system, the communication including a recommendation to initiate the cloud seeding based on the prediction of the impact on the atmospheric wind speed meeting the threshold for the wind turbine power output reduction.

18. The system of claim 17, further comprising the function to:
initiate the cloud seeding using the control system in response to the communication including the recommendation to initiate the cloud seeding.

19. The system of claim 17, further comprising the functions to:
estimate an amount of cloud seeding to generate rain at the location to reduce the atmospheric condition; and
send the amount of cloud seeding and the impact prediction to a control system for initiating a cloud seeding technique.

20. A computer program product for evaluating localized atmospheric conditions for selected cloud seeding to enhance localized electrical power generation from wind turbines, the computer program product comprising a computer readable storage medium having program instructions embodied therewith, the program instructions executable by a computer to cause the computer to perform functions, by the computer, comprising the functions to;
receive, at a computer, wind farm data related to a plurality of wind turbines for generating electrical power at a location, the wind farm data collected from sensors at the location;
receive, at the computer, data of atmospheric conditions at least in part at the location, the data including atmospheric wind speed;
assess, using the computer, an atmospheric condition in the atmosphere at the location using the wind farm data and the data of the atmospheric conditions;
predict, using the computer, an impact of the atmospheric condition on the atmospheric wind speed resulting in a wind turbine power output reduction;
determine, using the computer, whether to initiate cloud seeding to generate rain at the location and reduce the atmospheric condition, in response to the prediction of the impact on the atmospheric wind speed meeting a threshold for the wind turbine power output reduction; and
generate a communication to a control system, the communication including a recommendation to initiate the cloud seeding based on the prediction of the impact on the atmospheric wind speed meeting the threshold for the wind turbine power output reduction.
